(19) United States
(12) Patent Application Publication
(10) Pub. No.: US 2012/0330600 A1
(43) Pub. Date: Dec. 27, 2012

(54) ELECTRONIC DEVICE, POSITIONING METHOD, POSITIONING SYSTEM, COMPUTER PROGRAM PRODUCT, AND COMPUTER-READABLE RECORDING MEDIUM

(75) Inventors: Lun-Chia Kuo, Taichung City (TW); Yian-Shu Chu, New Taipei City (TW); Yi-Hsiung Huang, Tainan City (TW)

(73) Assignee: INDUSTRIAL TECHNOLOGY RESEARCH INSTITUTE, Hsinchu (TW)

(21) Appl. No.: 13/223,318

(22) Filed: Sep. 1, 2011

(30) Foreign Application Priority Data
Jun. 22, 2011 (TW) 100121810

(51) Int. Cl. G06F 15/00

(52) U.S. Cl. 702/150

(57) ABSTRACT

An electronic device, a positioning method, a positioning system, a computer program product, and a computer-readable recording medium are provided. The electronic device includes at least one wireless transceiver, at least one measurement unit (MU), and a processor. The processor is coupled with the wireless transceiver and the MU. The processor obtains distances between a plurality of participant devices through the wireless transceiver, wherein the participant devices include the electronic device. The processor obtains a displacement of each of the participant devices through the wireless transceiver and the MU and determines the spatial location of each of the participant devices according to the distances and the displacements.

### CROSS-REFERENCE TO RELATED APPLICATION

This application claims the priority benefit of Taiwan application serial no. 100121810, filed on Jun. 22, 2011. The entirety of the above-mentioned patent application is hereby incorporated by reference herein and made a part of this specification.

### TECHNICAL FIELD

The disclosure relates to an electronic device, a positioning method, a positioning system, a computer program product, and a computer-readable recording medium, which provide a positioning function by using a measurement unit (MU).

### BACKGROUND

A positioning system is a system or a device which can determine its own spatial location. For example, the Global Positioning System (GPS) is a widely used positioning system. Positioning systems can be applied to provide many different services, such as eldercare, shopping guidance, and community interactivity.

In most conventional positioning techniques, a location is determined through the measurement of received signal strength indicators (RSSI) and a triangulation or pattern matching technique based on existing reference points (for example, access points (APs) of a wireless local area network (WLAN)). In aforementioned pattern matching technique, a plurality of APs is deployed, and coordinates of each location and the RSSI of each AP received at the location are stored in a database in advance. A current spatial location can then be determined by comparing the RSSI of each AP received at the location with the data recorded in the database.

### SUMMARY

An electronic device, a positioning method, a positioning system, a computer program product, and a computer-readable recording medium are introduced herein, in which a plurality of electronic devices participate in a positioning service and serve as each other's reference point so that spatial locations of these electronic devices can be determined without the help of any access point (AP) of any wireless local area network (WLAN).

The disclosure provides an electronic device including at least one measurement unit (MU) and a processor. The processor determines an initial location of the electronic device, obtains a displacement of the electronic device through the MU, and determines a spatial location of the electronic device according to the initial location and the displacement.

The disclosure provides a positioning method executed by the electronic device described above. The positioning method includes following steps. An initial location of the electronic device is determined. A displacement of the electronic device is obtained through the MU. A spatial location of the electronic device is determined according to the initial location and the displacement.

The disclosure provides a computer program product and a computer-readable recording medium. The computer program product and the computer-readable recording medium respectively include a positioning program. The positioning method described above is accomplished when an electronic device loads and executes the positioning program.

The disclosure provides a positioning system including a plurality of electronic devices and a server. Each of the electronic devices includes a first wireless transceiver, a second wireless transceiver, and at least one MU. Each of the electronic devices obtains distances between the electronic device and the other electronic devices through the first wireless transceiver and obtains a displacement of the electronic device through the MU. Each of the electronic devices sends the distances and the displacement to the server through the second wireless transceiver. The server determines a spatial location of each of the electronic devices according to the distances and the displacement.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram of an electronic device according to an embodiment of the disclosure.

FIG. 2A, FIG. 2B, and FIG. 3 are flowcharts of a positioning method according to different embodiments of the disclosure.

FIG. 4 is a flowchart illustrating how to obtain the distances between different electronic devices according to an embodiment of the disclosure.

FIG. 5A and FIG. 5B are schematic diagrams illustrating how to determine the initial location of each participant device according to an embodiment of the disclosure.

FIG. 5C is a schematic diagram illustrating how to determine the initial location of each participant device according to another embodiment of the disclosure.

FIG. 6 is a flowchart illustrating how to determine the spatial location of each participant device by using the displacement of the participant device according to an embodiment of the disclosure.

FIG. 7 is a schematic diagram of an electronic device according to another embodiment of the disclosure.

FIGS. 8A-8C are schematic diagrams illustrating how to update the spatial location of a participant device by using the displacement of the participant device according to an embodiment of the disclosure.

FIGS. 9A-9C are schematic diagrams illustrating how to determine the spatial locations of participant devices by using distances and displacements of the participant devices according to an embodiment of the disclosure.

FIG. 10 is a flowchart illustrating how to obtain a positioning point according to the distances between participant devices according to an embodiment of the disclosure.

FIG. 11 is a schematic diagram illustrating how to obtain a positioning point according to the distances between participant devices according to an embodiment of the disclosure.

FIG. 12 is a flowchart illustrating how to determine the spatial locations of participant devices according to distances and displacements of the participant devices according to an embodiment of the disclosure.

FIGS. 13-19B are schematic diagrams illustrating how to determine the spatial locations of participant devices according to distances and displacements of the participant devices according to an embodiment of the disclosure.

FIGS. 20A-20C are schematic diagrams illustrating how to determine spatial locations of participant devices according to distances and displacements of the participant devices according to another embodiment of the disclosure.

FIGS. 21-22B are schematic diagrams illustrating how to determine the spatial locations of participant devices according to distances and displacements of the participant devices according to another embodiment of the disclosure.

FIG. 23A and FIG. 23B are flowcharts of positioning methods according to another embodiment of the disclosure.

FIG. 24 is a schematic diagram illustrating an application of electronic devices and a positioning method according to an embodiment of the disclosure.

FIG. 25 is a schematic diagram of a positioning system according to an embodiment of the disclosure.

### DETAILED DESCRIPTION OF DISCLOSED EMBODIMENTS

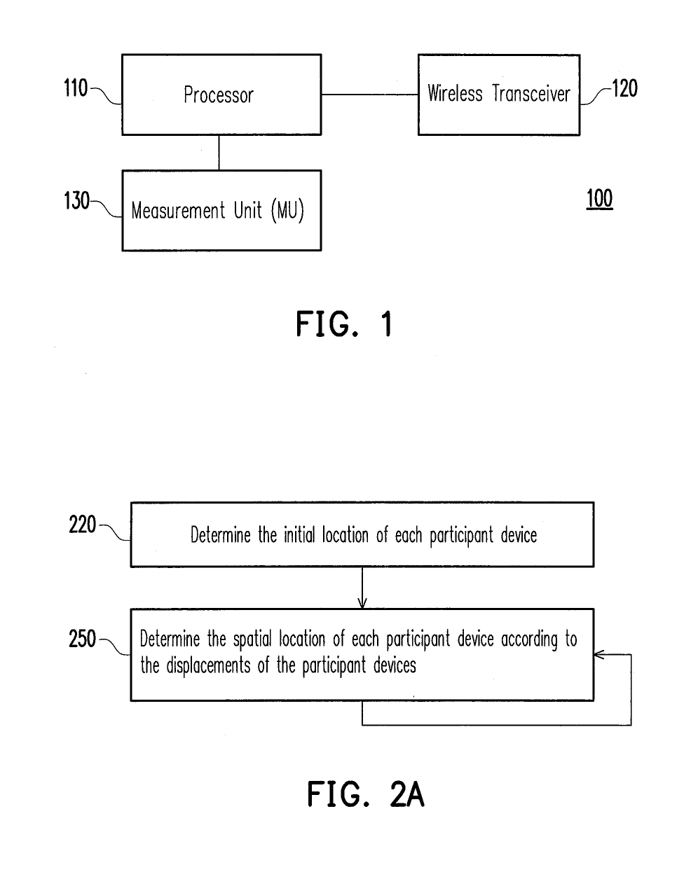

FIG. 1 is a diagram of an electronic device 100 according to an embodiment of the disclosure. The electronic device 100 is one of a plurality of electronic devices (referred to as participant devices thereinafter) which participate in the positioning service provided by the present embodiment. The electronic device 100 includes a processor 110, a wireless transceiver 120, and a measurement unit (MU) 130. In other embodiments, the electronic device 100 may include more than one MU. The wireless transceiver 120 supports Wi-Fi, Wi-Fi direct, Bluetooth, ZigBee, or any other communication standard capable of measuring received signal strength indicator (RSSI). Only one wireless transceiver 120 is illustrated in FIG. 1. However, in other embodiments of the disclosure, the electronic device 100 can also include multiple wireless transceivers, and these wireless transceivers can support different wireless communication standards. The processor 110 is coupled with the wireless transceiver 120 and the MU 130. The processor 110 executes all the following procedures and calculations. In the present positioning method, the processor 110 obtains distances between the participant devices through the wireless transceiver 120. Besides, the processor 110 obtains a displacement of each participant device through the wireless transceiver 120 and the MU 130 and determines a spatial location of each participant device according to the distances and the displacement of the participant device.

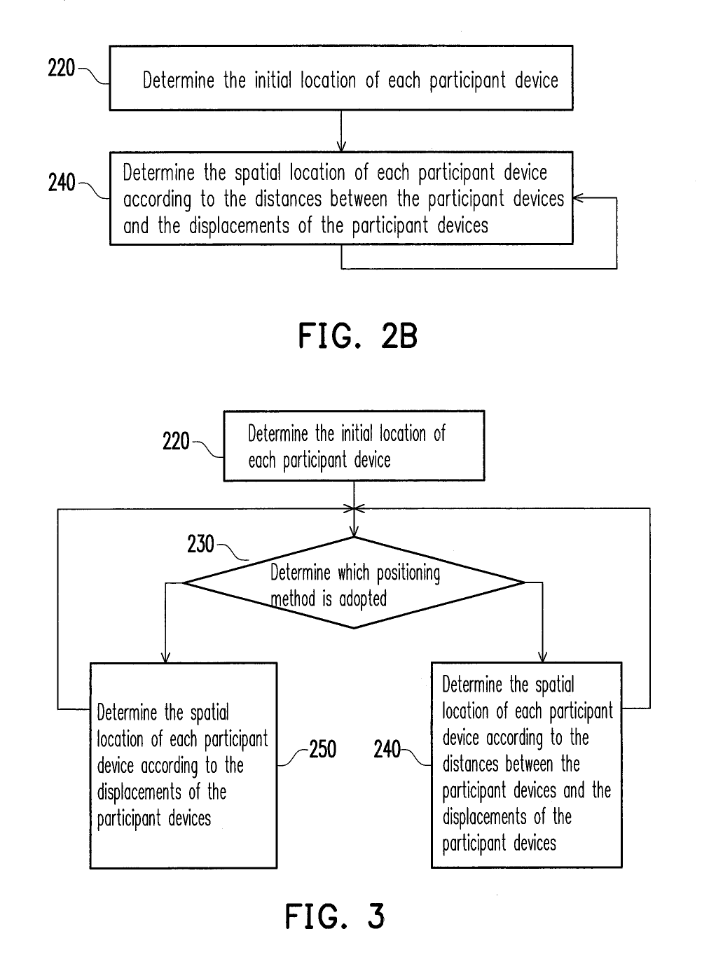

FIG. 2A is a flowchart of a positioning method according to an embodiment of the disclosure. Each aforementioned participant devices can execute the positioning method individually. As to the electronic device 100, the positioning method can be executed by the processor 110. First, the initial location of each participant device is determined (step 220). Then, the spatial location of each participant device is determined according to the displacements of the participant devices (step 250).

FIG. 2B is a flowchart of a positioning method according to another embodiment of the disclosure. Each aforementioned participant devices can execute the positioning method individually. As to the electronic device 100, the positioning method can be executed by the processor 110. First, the initial location of each participant device is determined (step 220). Then, the spatial location of each participant device is determined according to the distances between the participant devices and the displacements of the participant devices (step 240).

In the present embodiment, the processor 110 measures the RSSIs of the other participant devices through the wireless transceiver 120, so as to estimate the distances between the other participant devices and the electronic device 100 and determine the spatial locations of the participant devices according to these distances. However, in some communication standards (for example, the Bluetooth standard), the RSSIs can only be measured at specific intervals. In order to shorten the time interval between positioning operations, a positioning step based on only the displacement of each participant device can executed, such as the step 250 in FIG. 2A and FIG. 3.

FIG. 3 is a flowchart of a positioning method according to yet another embodiment of the disclosure. Each of aforementioned participant devices can execute the positioning method individually. As to the electronic device 100, the positioning method can be executed by the processor 110. First, in step 220, the initial location of each participant device is determined. The step 220 in FIG. 3 is the same as the steps 220 in FIG. 2A and FIG. 2B. Then, which positioning method is adopted is determined (step 230). An option is going to step 250, wherein the spatial location of each participant device is determined according to the displacements of the participant devices. After that, step 230 is executed again. Another option is going to step 240, where the spatial location of each participant device is determined according to the distances between the participant devices and the displacements of the participant devices. Next, step 230 is executed again. The step 240 in FIG. 3 is the same as that in FIG. 2B.

The determination in step 230 can be done based on whether RSSIs are detected. Step 250 is executed if no latest RSSI is detected, and step 240 is executed if latest RSSIs are detected. Besides, one of steps 250 and 240 can also be selected based on other predetermined rules. For example, steps 250 and 240 are respectively executed at different predetermined time intervals.

The displacement of each participant device mentioned in step 250 is detected by a MU, such as an accelerometer or an e-compass. Because the output of the MU can be obtained any time, the displacement of the participant device can be calculated instantly. However, because a MU can only be used for estimating the relative displacement of a single device, it is impossible to obtain the starting point of a movement or establish reference between multiple devices. Besides, the performance of the MU may be affected by magnetic metals, such as iron, cobalt, and nickel. On the other hand, RSSIs can be converted into distances and used for determining relative positions of participant devices. However, distance estimation errors may be caused by wireless signal drifting or space shielding. In addition, the strengths of some wireless signals (for example, a Bluetooth signal) cannot be measured any time. In step 240, both MUs and RSSIs are adopted to perform the positioning operation, and advantages of these two concepts can be integrated to perform the positioning operation properly. In the flowchart illustrated in FIG. 3, step 240 or 250 is selectively executed, and step 250 (in which the positioning operation is performed based on only the displacements of the participant devices) can be executed instead of step 240 (in which wireless signal measurement has to be performed), so as to increase the update frequency of the positioning result.

In the present embodiment, each participant device uses a MU to estimate its own displacement, estimates the distances between the participant device and other participant devices according to the RSSIs of the other participant devices, and transmits and receives packets through a wireless transceiver to exchange aforementioned displacement and distance information. Each participant device estimates its own spatial location and the spatial locations of other participant devices by using its own displacement and distance information and the displacement and distance information of other participant devices. Thereby, accurate positioning results can be instantly obtained when no signal is received from any wireless network reference point or the positions of the wireless network reference points are unknown.

Each participant device can execute the positioning method illustrated in FIG. 2A, FIG. 2B, or FIG. 3 individually. Below, the positioning method will be described in detail by taking the electronic device 100 as an example.

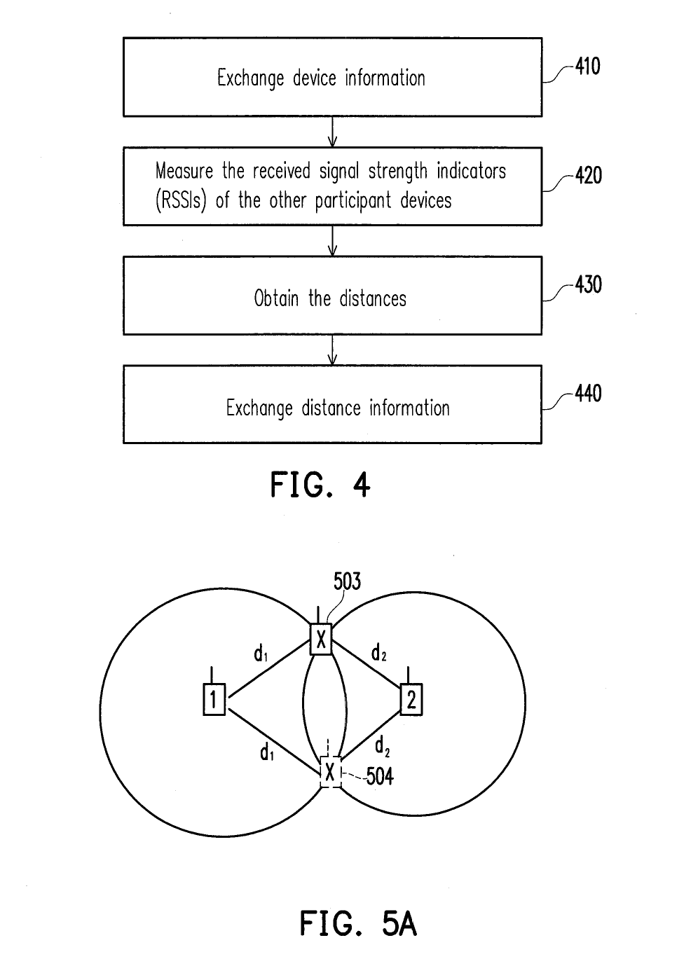

FIG. 4 is a flowchart illustrating how to obtain distances between participant devices by using the RSSIs of the participant devices according to an embodiment of the disclosure. Both step 220 and step 240 described above can contain the procedure illustrated in FIG. 4. First, participant devices transmit packets to each other through their wireless transceivers to exchange device information (step 410). As to the electronic device 100, the processor 110 sends the device information of the electronic device 100 to the participant devices other than the electronic device 100 through the wireless transceiver 120 and receives the device information of the other participant devices through the wireless transceiver 120. As to each of the other participant devices, the processor 110 measures a RSSI of the other participant device through the wireless transceiver 120 (step 420) and then obtains the distance between the other participant device and the electronic device 100 through table lookup according to the device information and the RSSI of the other participant device and the device information of the electronic device 100 (step 430). Next, the participant devices transmit packets to each other through their wireless transceivers to exchange the distance information obtained in step 430 (step 440). As to the electronic device 100, the processor 110 sends the distances between the other participant devices and the electronic device 100 to the other participant devices through the wireless transceiver 120 and receives distances between the other participant devices through the wireless transceiver 120.

Even though step 410 is executed before step 420 in the procedure illustrated in FIG. 4, the execution order of these two steps is not limited in the present embodiment, and step 410 may also be executed after step 420 or together with step 420.

Regarding each participant device, the device information thereof includes a wireless signal type (for example, Wi-Fi, or Bluetooth), a wireless signal transmission power, and a device type (for example, brand and model) of the participant device. The positioning service provider can provide a lookup table, wherein the lookup table includes such fields as transmitter device information, receiver device information, RSSI detected by receiver, and corresponding distance. The lookup table can be stored in each participant device or a remote server so that the participant devices can obtain the distances between the participant devices in step 430 through table lookup. Beside the table lookup mechanism, the positioning service provider may also provide a conversion formula corresponding to foregoing lookup table such that each participant device can obtain the distances between the participant devices in step 430 by using this conversion formula.

As shown in FIG. 2A, FIG. 2B, and FIG. 3, in order to determine the initial location of each participant device in step 220, the distances between the participant devices are obtained through the procedure illustrated in FIG. 4, and the initial location of each participant device is then determined according to these distances through any distance-based decentralized network positioning algorithm. The distance-based decentralized network positioning algorithm may be the Vivaldi algorithm or the rigidity theory algorithm. The Vivaldi algorithm is disclosed in following article:

F. Dabek, R. Cox, F. Kaashoek, and R. Morris, “Vivaldi: A Decentralized Network Coordinate System,” Proceedings of the 2004 conference on Applications, technologies, architectures, and protocols for computer communications, SIGCOMM '04, August 2004.

The rigidity theory is disclosed in following article:

G. Laman, “On Graphs and Rigidity of Plane Skeletal Structures,” Journal of Engineering Mathematics, Volume 4, Number 4, pp. 331-340, 1970.

The details of the Vivaldi algorithm and the rigidity theory algorithm can be referred to the foregoing articles therefore will not be described herein.

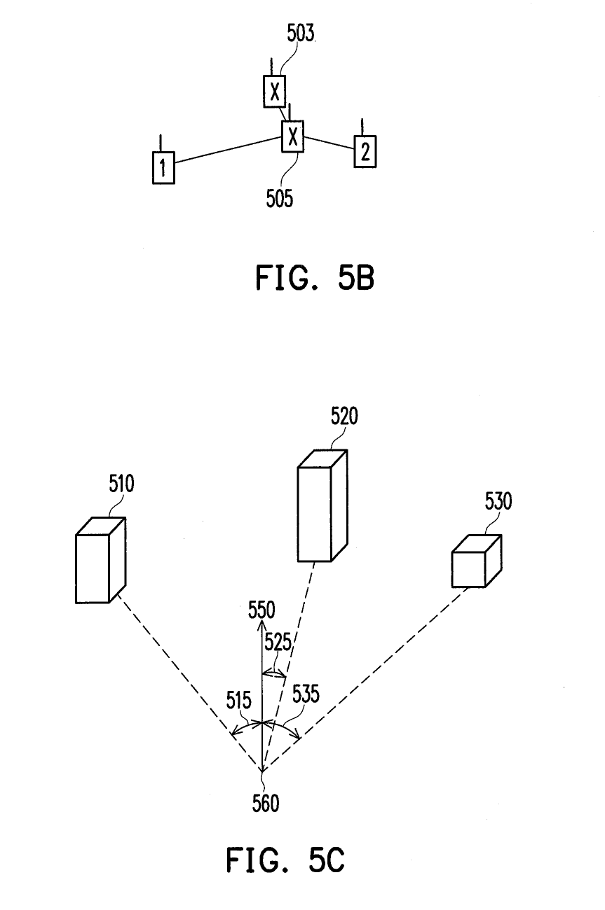

In the Vivaldi algorithm, if there are two possible positioning points, which one of the two positioning points is selected as the initial location of a participant device may not be determined. For example, as shown in FIG. 5A, when the distances between the participant device x and the participant devices 1 and 2 are respectively d₁ and d₂, the participant device x has two possible positioning points 503 and 504. It is impossible to select one of multiple possible positioning points based on the Vivaldi algorithm. As described above, each participant device can obtain its own displacement through the MU thereof. Thus, the positioning point can be selected according to the displacement of the participant device x. As shown in FIG. 5B, a positioning point 505 between the positioning points 503 and 504 is first calculated, wherein the positioning point 505 is a general average or a weighted average of the positioning points 503 and 504. The latest displacement vector obtained by the participant device x is added to the spatial coordinates of the positioning point 505. If the result runs towards the positioning point 503 and away from the positioning point 504, the positioning point 503 is selected as the initial location of the participant device x. Contrarily, if the result runs towards the positioning point 504 and away from the positioning point 503, the positioning point 504 is selected as the initial location of the participant device x.

Besides the distance-based decentralized network positioning algorithm, the initial location of each participant device may also be determined through identification of the image of a surrounding environment. In this technique, a plurality of subjects (for example, distinct landmarks or buildings) is selected in the area covered by the positioning service, and the appearance characteristics and spatial locations of these subjects are stored in a database in advance, wherein the database can be stored in each participant device or a remote server. While determining the initial location in step 220, the electronic device 100 captures an image of the surrounding environment. The processor 110 identifies a plurality of subjects in the image according to the appearance characteristics recorded in the database, determines an azimuth angle of each subject relative to the electronic device 100 according to the position of the subject in the image, and then determines the initial location of the electronic device 100 according to the azimuth angles and the spatial locations of the subjects recorded in the database.

FIG. 5C illustrates an example of determining an initial location through image identification according to the present embodiment. Herein the electronic device 100 identifies three subjects 510, 520, and 530 in the image, the azimuth angles of these subjects are respectively 515, 525, and 535, and the arrow 550 indicates north. Three dotted lines are extended (as shown in FIG. 5C) according to the spatial locations and the azimuth angles of the subjects 510, 520, and 530, and the crosspoint of these dotted lines is the initial location 560 of the electronic device 100.

After the initial location is determined through image identification, each participant device sends its own initial location to the other participant devices through the wireless transceiver thereof, so that each participant device can have the initial locations of the other participant devices.

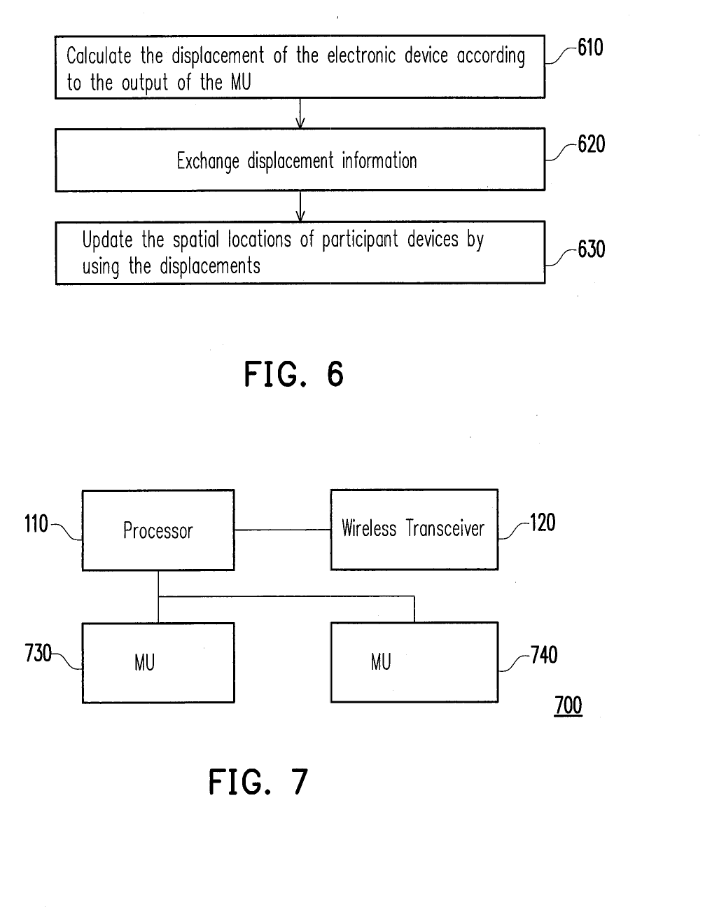

FIG. 6 is a detailed flowchart of step 250 according to an embodiment of the disclosure. This procedure can be executed by the electronic device 700 illustrated in FIG. 7. The major difference between the electronic device 700 and the electronic device 100 is that the electronic device 700 includes two MUs 730 and 740, wherein the MU 730 is a gyroscope or an e-compass, and the MU 740 is an accelerometer. The gyroscope can output the components of an angular acceleration of the electronic device 700 on three spatial coordinate axes, the accelerometer can output the components (including gravitational acceleration) of an acceleration of the electronic device 700 on three spatial coordinate axes, and the e-compass can output the orientation of the electronic device 700 relative to north.

The displacement of the electronic device 700 can be estimated by performing quadratic integration on the acceleration of the electronic device 700. However, an accelerometer is usually based on the coordinate system of an electronic device, while the displacement of the electronic device should be estimated based on the spatial coordinate system of the participant devices. Thus, the output of the accelerometer has to be converted with the help of the gyroscope or the e-compass. Accordingly, the processor 110 of the electronic device 700 converts the output of the MU 740 from the device coordinate system of the electronic device 700 to the spatial coordinate system of the participant devices according to the output of the MU 730 and performs quadratic integration on the output of the MU 740 to obtain the displacement of the electronic device 700 (step 610). In aforementioned quadratic integration, the first integration is to integrate the acceleration into velocity, and the second integration is to integrate the velocity into the displacement.

In other embodiments of the disclosure, the MUs 730 and 740 can be integrated into a single MU or split into more MUs.

Next, the participant devices transmit packets to each other through their wireless transceivers to exchange the displacement information obtained in step 610 (step 620). As to the electronic device 700, the processor 110 sends the displacement of the electronic device 700 to the other participant devices through the wireless transceiver 120 and receives the displacements of the other participant devices through the wireless transceiver 120. The processor 110 adds the displacement of each participant device to the spatial location of the participant device to update the spatial locations of the participant devices (step 630).

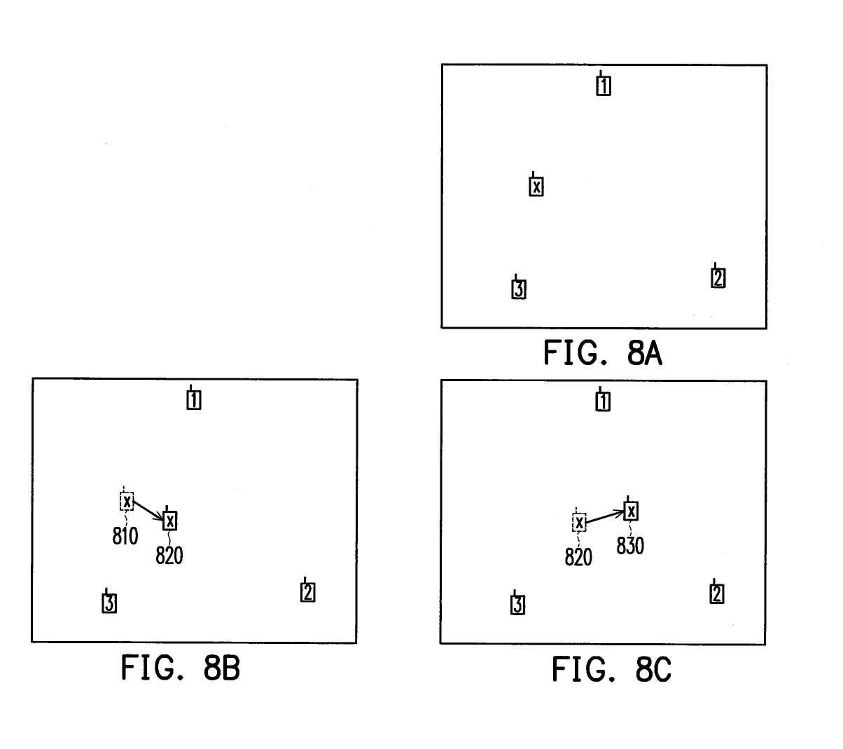

FIGS. 8A-8C illustrate an example of step 250 according to the present embodiment. Initially, the electronic device 700 displays the spatial locations of fourth participant devices 1-3 and x, as shown in FIG. 8A. Then, the processor 110 executes step 250 to update the spatial location of the participant device x from 810 to 820, as shown in FIG. 8B. Next, the processor 110 executes step 250 again to update the spatial location of the participant device x from 820 to 830, as shown in FIG. 8C. To simplify the drawings, the participant devices 1-3 in FIGS. 8A-8C remain still. However, the participant devices 1-3 may also have their own displacements and the electronic device 700 may also update the spatial location of the participant devices 1-3.

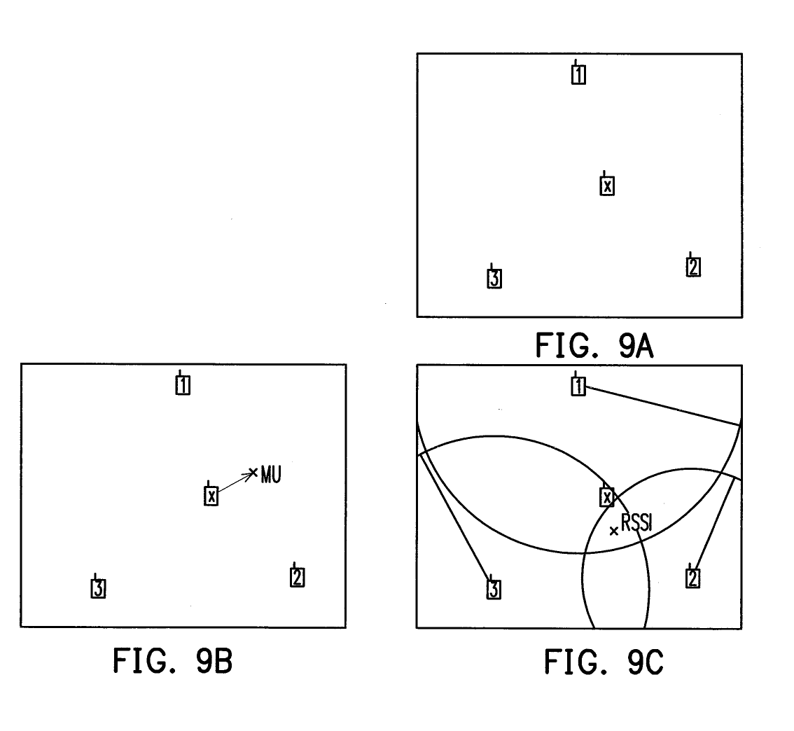

FIGS. 9A-9C are diagrams of step 240 according to an embodiment of the disclosure. The electronic device 100 executes step 240 on each participant device to determine the spatial location thereof. Below, this procedure will be described by taking the participant device x as an example. First, as shown in FIG. 9A, the spatial locations of the participant devices 1-3 and x are displayed before step 240 is executed. The spatial locations displayed in FIG. 9A are obtained in the latest positioning operation, and which may be the spatial locations determined in step 220, 240, or 250. The processor 110 updates the spatial location of the participant device x by using the displacement of the participant device x so as to obtain a displacement positioning point of the participant device x. The details of this operation are shown in FIG. 6. As shown in FIG. 9B, the processor 110 moves the participant device x from the position shown in FIG. 9A to the displacement positioning point MU. On the other hand, the processor 110 performs triangulation by using the distances between the participant device x and the other participant devices 1-3 obtained through the procedure illustrated in FIG. 4 and the latest spatial locations illustrated in FIG. 9A, so as to obtain a distance positioning point of the participant device x, such as the distance positioning point RSSI illustrated in FIG. 9C. After that, the processor 110 determines the spatial location of the participant device x according to the displacement positioning point MU and the distance positioning point RSSI. This spatial location is the spatial location determined in step 240.

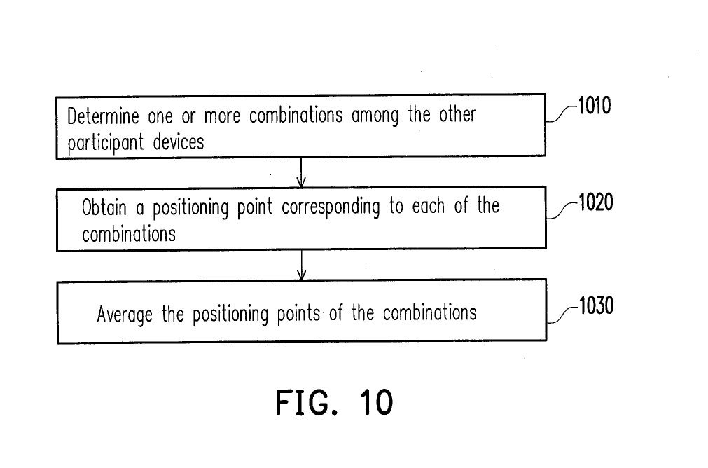

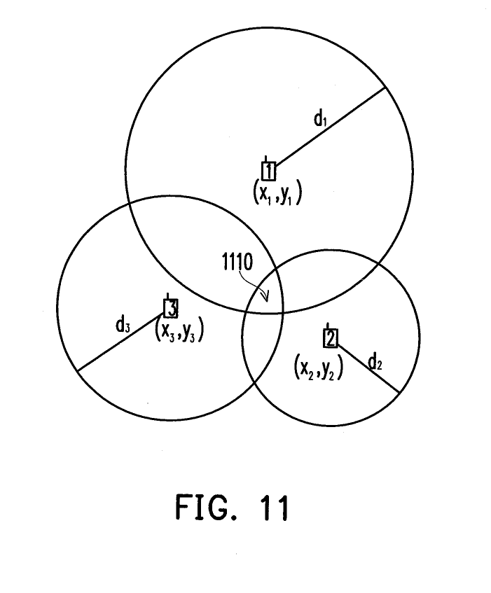

FIG. 10 is a flowchart illustrating how to obtain the distance positioning point RSSI according to the present embodiment. The triangulation can be performed by using three other participant devices. However, there may be more than three participant devices other than the participant device x. In this case, the processor 110 determines a combination or a plurality of combinations among the other participant devices based on a predetermined rule, wherein each of the combinations includes three of the other participant devices (step 1010). For example, aforementioned predetermined rule is to sort the participant devices other than the participant device x according to the latest displacements of the other participant devices (as shown in FIG. 9B) and then obtain all different combinations (there are totally C₃ⁿ different combinations) containing three of the n other participant devices having the smallest displacements, wherein n is a predetermined parameter. Next, the processor 110 obtains a positioning point corresponding to each of the combinations according to the distances between the three other participant devices in the combination and the participant device x through triangulation and a maximum likelihood method (step 1020). After that, the processor 110 averages the positioning points of the combinations to obtain the distance positioning point RSSI (step 1030).

FIG. 11 illustrates how to obtain the positioning point corresponding to each combination. This procedure will be explained by taking a combination containing the participant devices 1-3 as an example, wherein (x₁, y₁), (x₂, y₂), and (x₃, y₃) are respectively the coordinates of the spatial locations of the participant devices 1-3, and d₁, d₂, and d₃ are respectively the distances between the participant devices 1-3 and the participant device x obtained through the procedure illustrated in FIG. 4. As shown in FIG. 11, because a wireless signal may contain error and interference, the three circles drawn according to the spatial locations of the participant devices 1-3 and the radii d₁, d₂, and d₃ may not precisely intersect each other at a point. Most likely, the three circles produce an overlap area 1110, and the positioning point corresponding to the combination is located within the area 1110. In this case, the positioning point corresponding to the combination can be obtained through the maximum likelihood method, as expressed by following formula (1):

$${σ}_{x , y} = \vert \sqrt{{( x - {x}_{1} )}^{2} + {( y - {y}_{1} )}^{2}} - {d}_{1} \vert + \vert \sqrt{{( x - {x}_{2} )}^{2} + {( y - {y}_{2} )}^{2}} - {d}_{2} \vert + \vert \sqrt{{( x - {x}_{3} )}^{2} + {( y - {y}_{3} )}^{2}} - {d}_{3} \vert \qquad ( 1 )$$

The spatial coordinates (x, y) having the smallest σ_{x,y} is obtained through the maximum likelihood method, and the coordinates (x, y) is the coordinates the positioning point corresponding to the combination.

After obtaining the positioning point corresponding to each combination through the technique described above, a mean position (i.e., the distance positioning point RSSI) of the positioning points corresponding to all the combinations can be calculated by using following formula (2):

$$( {x}_{RSSI} , {y}_{RSSI} ) = \frac{1}{N} {\sum }_{i = 1}^{N} ( {x}_{i} , {y}_{i} ) \qquad ( 2 )$$

In foregoing formula (2), N is the number of the combinations (for example, C₃ⁿ) (xᵢ, yᵢ) is the coordinates of the positioning point corresponding to the combination I, and (x_{RSSI}, y_{RSSI}) is the coordinates the distance positioning point RSSI of the participant device x.

In step 1010, the combinations can be determined based on other predetermined rules or even randomly determined. In the present embodiment, the number of the combinations is not limited, and there may be only one combination. If there is only one combination, the positioning point corresponding to the combination is the distance positioning point RSSI.

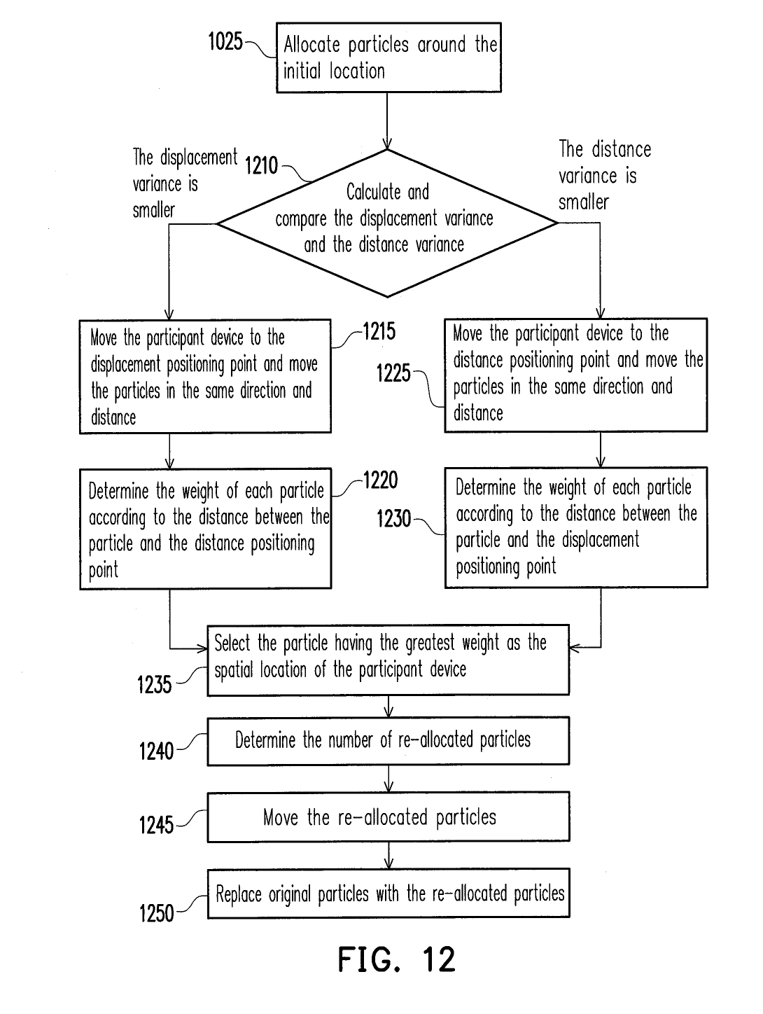

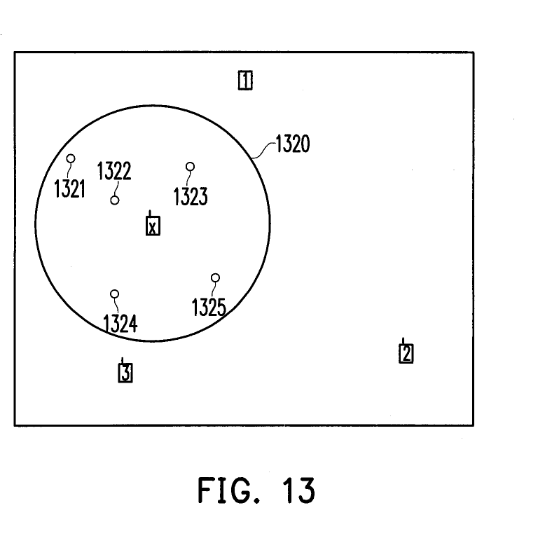

As described above, the processor 110 determines the spatial location of the participant device x according to the displacement positioning point MU illustrated in FIG. 9B and the distance positioning point RSSI illustrated in FIG. 9C. This spatial location is the spatial location determined in step 240. There are many algorithms for determining the spatial location of the participant device x according to the displacement positioning point MU and the distance positioning point RSSI. For example, the procedure illustrated in FIG. 12 is an implementation of the particle filtering algorithm, in which the spatial location of the participant device x is determined according to the displacement positioning point MU and the distance positioning point RSSI. The particle filtering algorithm is disclosed in following two articles:

N. J. Gordon, D. J. Salmond, and A. F. M. Smith, “Novel Approach to Nonlinear/Non-Gaussian Bayesian State Estimation,” IEE Proceedings F on Radar and Signal Processing, Volume 140, Issue 2, pp. 107-113, 1993.

M. S. Arulampalam, S. Maskell, N. Gordon, and T. Clapp, “A Tutorial on Particle Filters for Online Nonlinear/Non-Gaussian Bayesian Tracking,” IEEE Transactions on Signal Processing, Volume 50, Issue 2, pp. 174-188, 2002.

The procedure illustrated in FIG. 12 is an implementation of the particle filtering algorithm, and the technical details of the particle filtering algorithm can be referred to foregoing two articles and will not be described herein.

Below, the procedure illustrated in FIG. 12 will be explained. First, after the initial location of each participant device is determined in step 220, as shown in FIG. 13, a plurality of particles 1321-1325 is allocated within a predetermined area 1320 around the initial location of the participant device x according to a predetermined rule (step 1205). Even though only five particles are illustrated in FIG. 13, the number of particles is not limited in the disclosure. Generally speaking, the number of the particles is in direct proportion to the desired precision of the positioning operation. Aforementioned predetermined rule is to ensure that each point within the predetermined area has the same probability to be disposed with a particle and accordingly the particles can be evenly distributed.

Next, the processor 110 calculates a displacement variance and a distance variance of the participant device x and compares the two variances (step 1210). The foregoing two variances are calculated by using following formulae:

$$\begin{matrix}{Var}_{MU} = \frac{{\sum }_{i = 1}^{n} {( {X}_{MU , i} - \frac{{\sum }_{i = 1}^{n} {X}_{MU , i}}{n} )}^{2}}{n} & ( 3 ) \\ {Var}_{RSSI} = \frac{{\sum }_{i = 1}^{m} {( {X}_{RSSI , i} - \frac{{\sum }_{i = 1}^{m} {X}_{RSSI , i}}{m} )}^{2}}{m} & ( 4 )\end{matrix}$$

In foregoing formula (3), Var_{MU} is the displacement variance, n is a predetermined parameter, and X_{MU,1} to X_{MU,n} are the last n displacement values or displacement lengths of the participant device x obtained through the MU. In foregoing formula (4), Var_{RSSI} is the distance variance, m is a predetermined parameter, and X_{RSSI,1} to X_{RSSI,m} are the last m average distances between the participant device x and a subset of the other participant devices obtained according to the RSSIs. For example, if foregoing subset is composed of the participant devices 1-3 in FIG. 13, X_{RSSI,I} is one of the last m average distances between the participant device x and the participant devices 1-3 obtained according to the RSSIs. The subset can be determined according to any predetermined rule. However, each X_{RSSI,I} has to be generated by using the same subset.

The displacement variance and the distance variance are calculated to determine which one of the output signal of the MU and the wireless signal used by the wireless transceiver for measuring RSSI is more reliable. Because foregoing output signal and wireless signal may be interfered (may be considered high-frequency noises), the positioning result may be affected if the interfered signals are used. Thus, foregoing two variances are calculated and compared to determine which signal comes with smaller interference. Besides, the signal with smaller interference is used for allocating the particles, and the other signal is used for filtering out the high-frequency noises so as to eliminate any possible error.

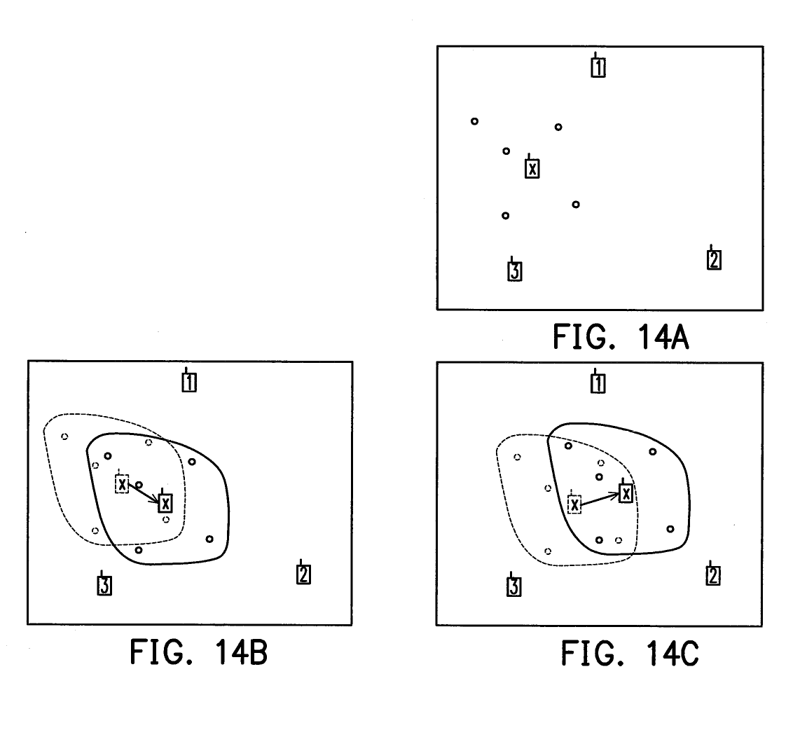

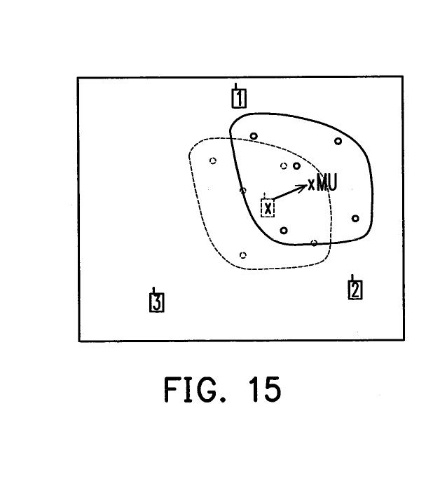

Thereby, when the displacement variance is smaller than the distance variance, the processor 110 moves the participant device x to the displacement positioning point MU and moves the particles in the same direction and distance as those of the movement of the participant device x (step 1215). All the particles of the participant device x are moved in this way every time when the spatial location of the participant device x changes. For example, as shown in FIGS. 14A-14C, the initial spatial locations of the participant devices x and 1-3 are as shown in FIG. 14A. Thereafter, when each time step 250 is executed to perform a positioning operation, the processor 110 updates the spatial location of the participant device x by using the displacement detected by the MU and moves the particles in the same direction and distance as those of the movement of the participant device x, as shown in FIG. 14B and FIG. 14C. FIG. 14A and FIG. 14B illustrate two consecutive location updates, wherein the dotted line indicates the positions of the participant device x and the particles thereof before the update, and the solid line indicates the positions of the participant device x and the particles thereof after the update. While obtaining the displacement positioning point MU in step 240, the processor 110 moves the participant device x to the displacement positioning point MU and moves the particles in the same direction and distance as those of the movement of the participant device x, as shown in FIG. 15.

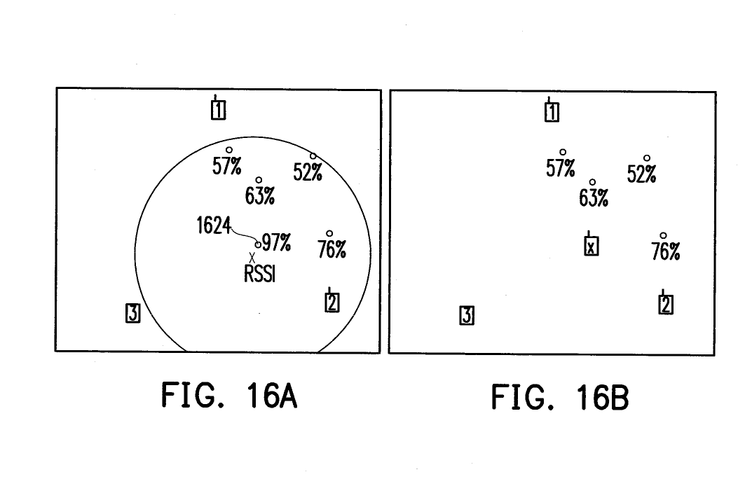

Next, as shown in FIG. 16A, the processor 110 determines a weight of each of the particles, wherein the weight of each particle is in inverse proportion to the distance between the particle and the distance positioning point RSSI (step 1220). The conversion between the distance and weight of each particle can be carried out based on any predetermined rule presenting an inverse proportion, such as the Gaussian distribution adopted in the present embodiment. Thereafter, the processor 110 selects the particle having the greatest weight as the spatial location of the participant device x (step 1235). This spatial location is the spatial location determined in step 240. In the example illustrated in FIG. 16A and FIG. 16B, the processor 110 selects the particle 1624 having the greatest weight as the spatial location of the participant device x.

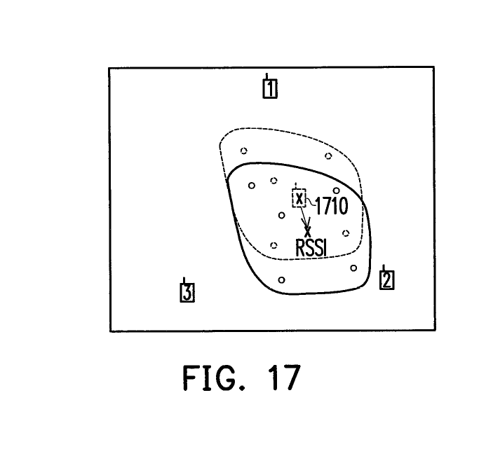

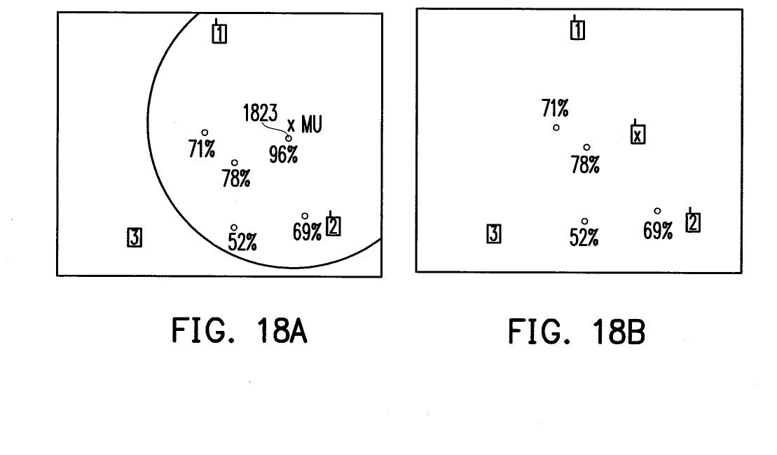

Back to step 1210, when the distance variance is smaller than the displacement variance, as shown in FIG. 17, the processor 110 moves the participant device x from the latest spatial location 1710 (may be determined in step 220, 240, or 250) to the distance positioning point RSSI and moves all the particles in the same direction and distance as those of the movement of the participant device x (step 1225). After that, as shown in FIG. 18A, the processor 110 determines a weight of each particle, wherein the weight of each particle is in inverse proportion to the distance between the particle and the displacement positioning point MU (step 1230). Step 1230 is very similar to step 1220, and the only difference is that in step 1230, the weight of each particle is determined based on the displacement positioning point MU. Next, the processor 110 selects the particle having the greatest weight as the spatial location of the participant device x (step 1235). This spatial location is the spatial location determined in step 240. In the example illustrated in FIG. 18A and FIG. 18B, the processor 110 selects the particle 1823 having the greatest weight as the spatial location of the participant device x.

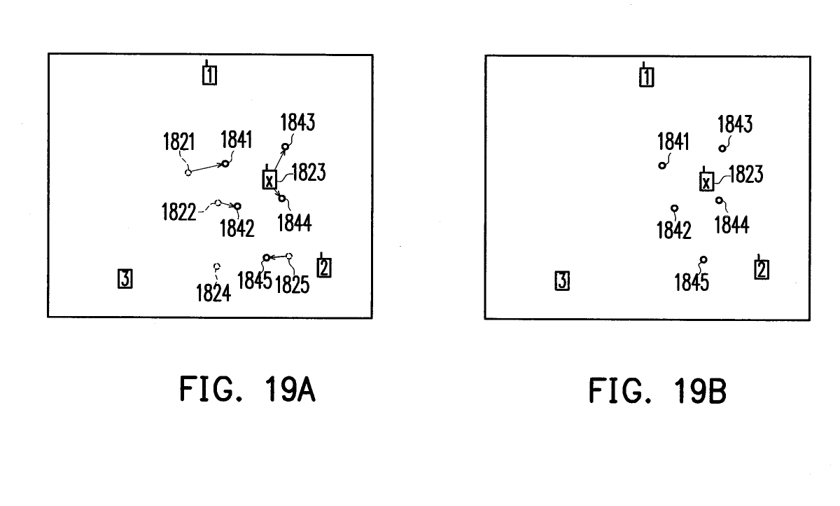

In following steps 1240 and 1245, the particles are re-allocated according to a predetermined rule. First, the number of the re-allocated particles is determined (step 1240). For example, the weight of each original particle is input into a predetermined increasing function to determine the number of particles re-allocated around the original particle. The greater weight an original particle has, the more particles will be re-allocated around the particle. If the weight of an original particle is lower than a threshold, no particle is re-allocated around this particle. The initial location of each re-allocated particle is the same as the location of the corresponding original particle. Thereafter, each re-allocated particle is moved according to another predetermined rule (step 1245). The re-allocated particles are moved because the wireless signal and the output signal of the MU may contain error therefore are not reliable. In the present embodiment, the particles are randomly moved. The particles may also be moved in a regular manner if the noises and errors in the wireless signal and the output signal of the MU are well understood. FIG. 19A illustrates an example of moving the particles, wherein 1821-1825 indicate the original particles, and 1841-1845 indicate the re-allocated and moved particles. The arrows in FIG. 19A indicate the movement paths of the new particles, wherein no particle is re-allocated around the particle 1824 since its weight is very small.

Next, the original particles are replaced with the re-allocated particles (step 1250). For example, as shown in FIG. 19A and FIG. 19B, the original particles 1821-1825 are replaced with the re-allocated particles 1841-1845. The re-allocated particles will be used in following positioning operation. Subsequently, every time when the participant device x is moved in step 240 or 250, all the particles of the participant device x are moved in the same direction and distance.

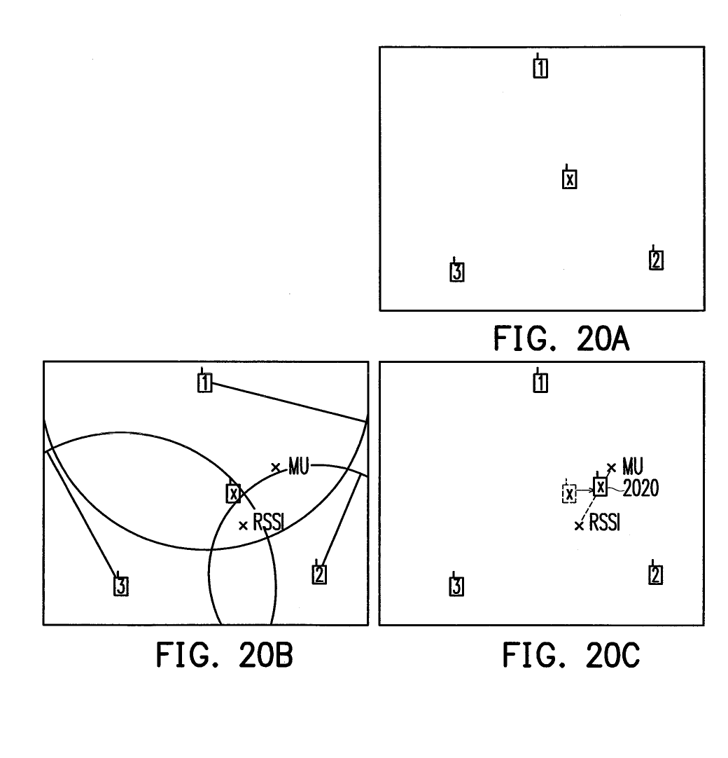

It is not limited in step 240 that the spatial location of a participant device has to be determined through the particle filtering algorithm. A weighted average of the spatial coordinates of the displacement positioning point and the distance positioning point may also be calculated and serves as the spatial location determined in step 240, as shown in FIGS. 20A-20C. FIG. 20A illustrates the spatial locations (i.e., the latest spatial locations determined before the current execution of step 240) of the participant devices 1-3 and x. FIG. 20B illustrates the displacement positioning point MU and the distance positioning point RSSI of the participant device x. In FIG. 20C, the processor 110 designates a weighted average of the spatial coordinates of the displacement positioning point MU and the distance positioning point RSSI as the spatial location of the participant device x. This spatial location 2020 is located between the displacement positioning point MU and the distance positioning point RSSI.

In the calculation of aforementioned weighted average, there are many ways to determine the weights of the displacement positioning point MU and the distance positioning point RSSI. For example, the weights of the two positioning points can be determined according to the displacement variance and the distance variance calculated by using foregoing formulae (3) and (4), so as to calculate the weighted average. This technique is an application of the Kalman filtering algorithm. The Kalman filtering algorithm is disclosed in following article:

R. E. Kalman, “A New Approach to Linear Filtering and Prediction Problems,” Transaction of the ASME—Journal of Basic Engineering, pp. 35-45, March, 1960.

Technical details of the Kalman filtering algorithm can be referred to foregoing article and will not be described herein.

Regarding the weighted average, a displacement confidance parameter and a distance confidance parameter of the participant device x may also be calculated and respectively serve as the weights of the displacement positioning point MU and the distance positioning point RSSI, as expressed by following formula (5):

$$( x , y ) = \frac{{C}_{RSSI}}{{C}_{RSSI} + {C}_{MU}} ( {x}_{RSSI} , {y}_{RSSI} ) + \frac{{C}_{MU}}{{C}_{RSSI} + {C}_{MU}} ( {x}_{MU} , {y}_{MU} ) \qquad ( 5 )$$

In foregoing formula (5), (x, y) is the spatial coordinates of the participant device x (i.e., the weighted average), (x_{RSSI}, y_{RSSI}) and (x_{MU}, y_{MU}) are respectively the spatial coordinates of the distance positioning point RSSI and the displacement positioning point MU, and C_{RSSI} and C_{MU} are respectively the distance confidance parameter and the displacement confidance parameter.

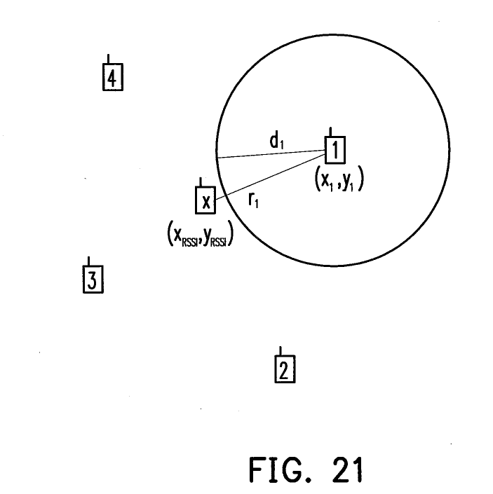

The distance confidance parameter C_{RSSI} is derived from an error parameter E_{RSSI} of RSSI, and the concept thereof is as shown in FIG. 21. FIG. 21 illustrates the latest spatial locations of the participant devices 1-4 and x before the current execution of step 240. The spatial locations shown in FIG. 21 may be determined in step 220, 240, or 250. In FIG. 21, (x, y) is the spatial coordinates of the participant device 1, (x_{RSSI}, y_{RSSI}) is the spatial coordinates of the distance positioning point RSSI of the participant device x, d₁ is the distance between the participant device 1 and the participant device x obtained by measuring a RSSI through the wireless transceiver, and r₁ is the distance between the participant device 1 and the distance positioning point RSSI. Similarly, each of the participant devices i except the participant device x has two corresponding distances dᵢ and rᵢ. Assuming that the number of participant devices except the participant device x is n, the error parameter E_{RSSI} is calculated by using following formula:

$${E}_{RSSI} = \frac{1}{n} {\sum }_{i = 1}^{n} \vert {d}_{i} - {r}_{i} \vert \qquad ( 6 )$$

The distance confidance parameter C_{RSSI} is calculated by using following formula:

$${C}_{RSSI} = max ( ( 1 - \frac{{E}_{RSSI}}{δ} ) \times 100 \% , 0 \% ) \qquad ( 7 )$$

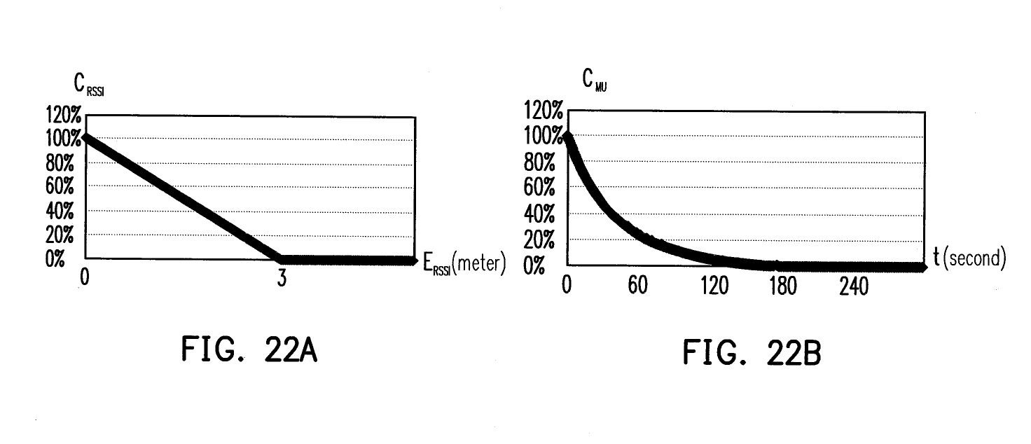

In foregoing formula (7), δ is a predetermined threshold, and max is a maximum function. If δ is set to 3, the distance confidance parameter C_{RSSI} is as shown in FIG. 22A. In FIG. 22A, the ordinate indicates the distance confidance parameter C_{RSSI}, the abscissa indicates the error parameter E_{RSSI}, and the abscissa unit is meter. In other embodiments of the disclosure, δ may also be set to other values.

As to the displacement confidance parameter C_{MU}, because an accumulated error may be produced on the displacement determined through the MU, the longer the continuous moving time of a participant device is, the less reliability the displacement thereof will be. Thus, the displacement confidance parameter C_{MU} can be calculated by using following two formulae:

$$\begin{matrix}{C}_{MU} = 100 \% \times {e}^{- λ t} & ( 8 ) \\ λ = \frac{ln 2}{T} & ( 9 )\end{matrix}$$

Foregoing formula (8) is a conventional half-life equation, wherein t is the continuous moving time of the participant device x, and t is counted from the first movement of the participant device x that is detectable to the MU of the participant device x since last time the spatial location of the participant device x is determined in step 240. In foregoing formula (9), T is a half life corresponding to formula (8), and the value of T can be determined by the positioning service provider. If T is set to 30 seconds, the displacement confidance parameter C_{MU} is as shown in FIG. 22B. In FIG. 22B, the ordinate indicates the displacement confidance parameter C_{MU}, the abscissa indicates the continuous moving time t, and the abscissa unit is second. In other embodiments of the disclosure, T can be set to other values.

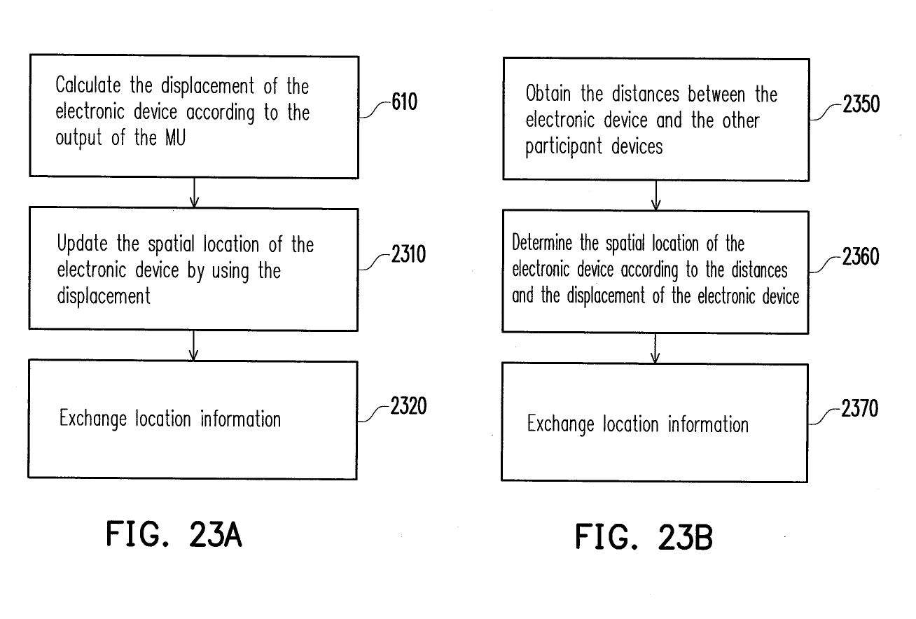

In step 250 of FIG. 2A and FIG. 3 and the procedure illustrated in FIG. 6, a plurality of electronic devices participating in a positioning service exchange displacement information with each other, and then each electronic device respectively calculates its own spatial location and the spatial locations of the other participant devices according to the displacement information. In other embodiments of the disclosure, each electronic device may also calculate only its own spatial location, and then all the participant devices exchange their location information with each other, as shown in FIG. 23A. Taking the electronic device 100 as an example, the processor 110 calculates the displacement of the electronic device 100 according to the output of the MU 130 (step 610). Step 610 in FIG. 23A is the same as step 610 in FIG. 6, and the details thereof won't be described herein. Next, the processor 110 adds the displacement of the electronic device 100 to the initial location (determined in step 220) or the spatial location (determined in step 240 or 250) of the electronic device 100 to update the spatial location of the electronic device 100 (step 2310). The participant devices of the positioning services can exchange their spatial locations obtained in step 2310 with each other (step 2320). As to the electronic device 100, the processor 110 sends the spatial location of the electronic device 100 to the other participant devices through the wireless transceiver 120 and receives the spatial locations of the other participant devices through the wireless transceiver 120.

In step 240 of FIG. 2B and FIG. 3, a plurality of electronic devices participating in a positioning service exchange their displacement and distance information with each other, and then each electronic device respectively calculates its own spatial location and the spatial locations of the other participant devices according to the displacement and distance information. In other embodiments of the disclosure, each electronic device may only calculate its own spatial location, and then all the participant devices may exchange their location information with each other, as shown in FIG. 23B. Taking the electronic device 100 as an example, the processor 110 executes steps 410-430 in FIG. 4 to obtain the distances between the electronic device 100 and the other participant devices through the wireless transceiver 120 (step 2350). Then, the processor 110 determines the spatial location of the electronic device 100 according to these distances and the displacement of the electronic device 100 (step 2360). Step 2360 is similar to step 240 in FIG. 2B and FIG. 3. However, in step 2360, the electronic device 100 needs to determine only its own spatial location but not the spatial locations of the other participant devices. The participant devices of the positioning service exchange the spatial locations obtained in step 2360 with each other (step 2370). As to the electronic device 100, the processor 110 sends the spatial location of the electronic device 100 to the other participant devices through the wireless transceiver 120 and receives the spatial locations of the other participant devices through the wireless transceiver 120.

Besides the electronic device and the positioning method described above, the disclosure also provides a computer program product and a computer-readable recording medium. The computer program product and the computer-readable recording medium respectively include a positioning program. The positioning method described above can be accomplished after the electronic device loads and executes the positioning program. The computer program product can be stored in a recording medium readable to a computer or an electronic device or downloaded via a network. The computer-readable recording medium can be any physical medium which can store or record computer programs, such as a CD, a magnetic disc, or a memory card.

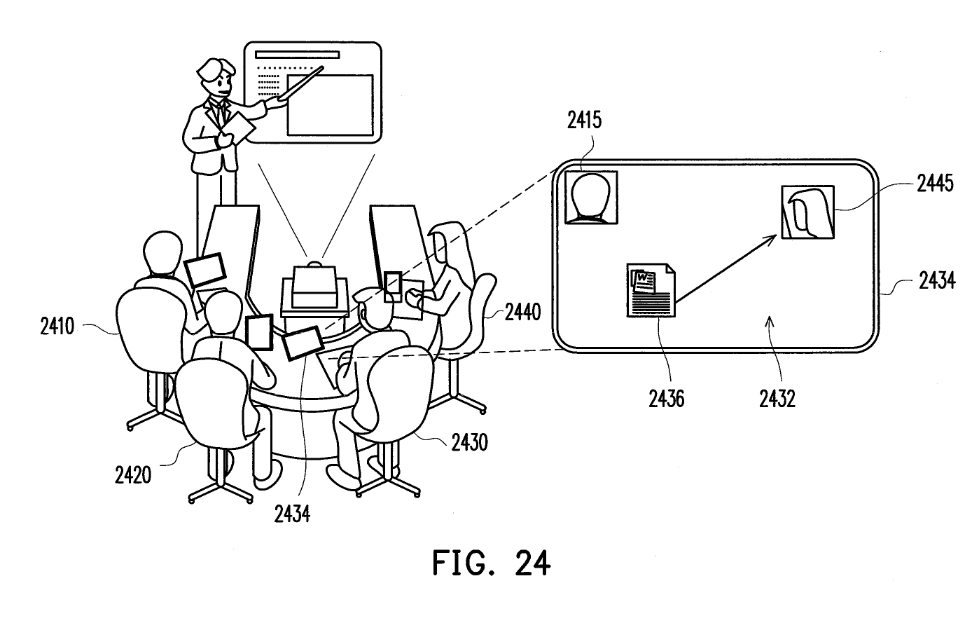

The electronic device, positioning method, computer program product, and computer-readable recording medium described above can be applied in many ways. For example, they can be applied to provide a friend locating service. This service allows friends to find each other in a public place, such as a library or a shopping mall. Foregoing electronic device, positioning method, computer program product, and computer-readable recording medium may also be applied to provide a cross-device vectored transmission service, as shown in FIG. 24.

The four users 2410, 2420, 2430, and 2440 in FIG. 24 respectively have an electronic device participating in a vectored transmission service, wherein each of the electronic devices executes the positioning method described above to determine the spatial locations of its own and the other electronic devices. Assuming that each user always carries his/her electronic device (i.e., each user and his/her electronic device are always at the same location), in the vectored transmission service, each user and his/her electronic device can be considered as a single object. Each electronic device includes a display and an input interface. The display can display the spatial location of each electronic device (i.e., the spatial location of the corresponding user), and the input interface can receive an operation command corresponding to a specific electronic device (i.e., an operation command corresponding to the user of the specific electronic device).

For example, the electronic device 2434 of the user 2430 includes a touch screen 2432, wherein the aforementioned display and input interface are integrated into the touch screen 2432. In FIG. 24, the touch screen 2432 displays the spatial location 2415 of the user 2410 and the spatial location 2445 of the user 2440. The user 2430 may issue an operation command corresponding to the electronic device of the user 2440 through the touch screen 2432 (for example, by dragging an electronic file 2436 to a location image 2445 representing the user 2440). The processor of the electronic device 2434 receives the operation command through the touch screen 2432 and then sends the electronic file 2436 to the electronic device of the user 2440. In the vectored transmission service described above, identify related information of other users is not required, and electronic files can be transmitted as long as the relative positions of other users are obtained.

The positioning method described in each of foregoing embodiments is a distributed positioning method, in which each electronic device respectively executes the positioning method, and each electronic device determines the spatial location of each electronic device according to the distances between all the electronic devices and the displacement of each electronic device through its own wireless transceiver and MU. However, a centralized positioning method is also provided by the disclosure.

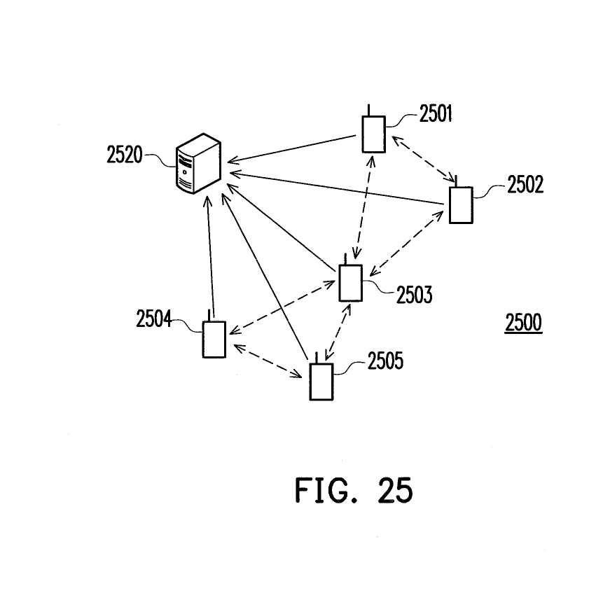

FIG. 25 is a diagram of a centralized positioning system 2500 according to an embodiment of the disclosure. The positioning system 2500 includes electronic devices 2501-2505 and a server 2520. Each of the electronic devices 2501-2505 includes two wireless transceivers and at least one MU. The two wireless transceivers are similar to the wireless transceiver 120 illustrated in FIG. 1 and FIG. 7, wherein the first wireless transceiver supports Wi-Fi, Wi-Fi direct, Bluetooth, ZigBee, or any other communication standard which supports RSSI measurement, and the second wireless transceiver supports Wi-Fi, 3G, or any other similar wireless communication standard. The MU of each of the electronic devices 2501-2505 is the same as the MU 130 illustrated in FIG. 1 or the MUs 730 and 740 illustrated in FIG. 7.

Each of the electronic devices 2501-2505 respectively executes steps 410-430 in FIG. 4 to obtain the distances between the electronic device and the other electronic devices through the first wireless transceiver. Each of the electronic devices 2501-2505 also executes step 610 in FIG. 6 to obtain a displacement of the electronic device through the MU. After that, each of the electronic devices 2501-2505 sends foregoing distances and displacement to the server 2520 through the second wireless transceiver. Because all the distances and displacements are analyzed by the server 2520, the electronic devices 2501-2505 need not to exchange the distance and displacement information with each other.

Except aforementioned steps executed by the electronic devices 2501-2505, all the other steps in the positioning method described in each of foregoing embodiments are executed by the server 2520. As shown in FIG. 3, the server 2520 determines an initial location of each of the electronic devices 2501-2505 (step 220). As described above, the server 2520 can determine the initial location of each electronic device according to the distances between the electronic devices 2501-2505 and any distance-based decentralized network positioning algorithm. Or, as shown in FIG. 5C, each of the electronic devices 2501-2505 can obtain an image of a surrounding environment, identify subjects in the image to obtain its own initial location, and then send the initial location to the server 2520 through the second wireless transceiver. Or, each of the electronic devices 2501-2505 can obtain an image of a surrounding environment and then send the image to the server 2520 through the second wireless transceiver. Next, as shown in FIG. 5C, the server 2520 can identify subjects in the image provided by each electronic device to determine the initial location of the electronic device. For identifying the subjects, the appearance characteristics and spatial locations of the subjects are stored in a database in advance, and the database is stored in the server 2520 or another independent server.

Thereafter, the server 2520 determines the spatial location of each of the electronic devices 2501-2505 according to the displacement of the electronic device (step 250) or according to the displacement of the electronic device and the distances between the electronic devices 2501-2505 (step 240). The details of foregoing steps have been described in foregoing embodiments therefore will not be described herein.

After the server 2520 determines the spatial location of each electronic device, each electronic device receives the spatial locations of the electronic devices 2501-2505 from the server 2520 through the second wireless transceiver. Accordingly, each of the electronic devices 2501-2505 can display its own spatial location and the spatial locations of the other electronic devices and provide various related services, such as the vectored transmission service illustrated in FIG. 24.

The number of electronic devices illustrated in each drawing of the disclosure is only an example, and the number of electronic devices participating in the aforementioned positioning service or other services is not limited in the disclosure.

Even though two-dimensional positioning is described in each of the foregoing embodiments, the disclosure is not limited thereto. In other embodiments, one-dimensional or three-dimensional positioning may also be performed by using the same technique.

Many existing electronic devices (for example, smart phones and notebook computers) come with wireless transceivers and MUs. As described above, in the electronic device, the positioning method, the positioning system, the computer program product, and the computer-readable recording medium provided by the disclosure, RSSIs of other devices are measured by using an existing wireless transceiver to determine the distances of the other devices, and the displacement of the electronic device can be calculated by using an existing MU. Accordingly, a plurality of electronic devices can be positioned according to the displacements or the distances and the displacements, so as to generate a very accurate positioning result. Since the wireless transceiver and the MU comes with the electronic device itself, in the electronic device, the positioning method, the positioning system, the computer program product, and the computer-readable recording medium, a plurality of electronic devices can be positioned without any reference point (for example, access points (APs) of a wireless local area network (WLAN)). Thereby, the technique provided by the disclosure is suitable for an environment in which no wireless network signal can be received or the positions of positioning reference points cannot be obtained.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An electronic device, comprising:
at least one measurement unit (MU); and
a processor, determining an initial location of the electronic device, obtaining a displacement of the electronic device through the MU, and determining a spatial location of the electronic device according to the initial location and the displacement.

2. The electronic device according to claim 1, further comprising:
at least one wireless transceiver, wherein the electronic device is one of a plurality of participant devices, the processor obtains distances between the participant devices through the at least one wireless transceiver and determines an initial location of each of the participant devices according to the distances through a distance-based decentralized network positioning algorithm.

3. The electronic device according to claim 2, wherein the distance-based decentralized network positioning algorithm is a Vivaldi algorithm or a rigidity theory algorithm.

4. The electronic device according to claim 3, wherein the processor obtains a displacement of each of the participant devices through the at least one wireless transceiver and the MU and determines the initial location of each of the participant devices according to the distances, the displacements, and the Vivaldi algorithm.

5. The electronic device according to claim 1, further comprising:
at least one wireless transceiver, wherein the electronic device is one of a plurality of participant devices, and the processor identifies a plurality of subjects in an image of a surrounding environment, determines an azimuth angle of each of the subjects relative to the electronic device according to a position of the subject in the image, determines the initial location of the electronic device according to spatial locations and the azimuth angles of the subjects, and sends the initial location to the other participant devices through the at least one wireless transceiver, wherein appearance characteristics and the spatial locations of the subjects are stored in a database in advance.

6. The electronic device according to claim 1, further comprising:
at least one wireless transceiver, wherein the electronic device is one of a plurality of participant devices, and the processor calculates the displacement of the electronic device according to an output of the MU, adds the displacement of the electronic device to the initial location or the spatial location of the electronic device to update the spatial location of the electronic device, sends the spatial location of the electronic device to the other participant devices through the at least one wireless transceiver, and receives spatial locations of the other participant devices through the at least one wireless transceiver.

7. The electronic device according to claim 1, further comprising:
at least one wireless transceiver, wherein the electronic device is one of a plurality of participant devices, and the processor calculates the displacement of the electronic device according to an output of the MU, sends the displacement of the electronic device to the other participant devices through the at least one wireless transceiver, receives displacements of the other participant devices through the at least one wireless transceiver, and adds the displacement of each of the plurality of participant devices to an initial location or a spatial location of the participant device to update the spatial location of the participant device.

8. The electronic device according to claim 7, wherein the MU comprises a first MU and a second MU, and the processor converts an output of the second MU from a device coordinate system of the electronic device to a spatial coordinate system of the plurality of participant devices according to an output of the first MU and integrates the output of the second MU to obtain the displacement of the electronic device.

9. The electronic device according to claim 8, wherein the first MU is a gyroscope or an e-compass, and the second MU is an accelerometer.

10. The electronic device according to claim 1, further comprising:
at least one wireless transceiver, wherein the electronic device is one of a plurality of participant devices, and the processor obtains distances between the electronic device and the other participant devices through the at least one wireless transceiver, determines the spatial location of the electronic device according to the distances and the displacement, sends the spatial location of the electronic device to the other participant devices through the at least one wireless transceiver, and receives spatial locations of the other participant devices through the at least one wireless transceiver.

11. The electronic device according to claim 10, wherein the processor sends a device information of the electronic device to the plurality of participant devices other than the electronic device through the at least one wireless transceiver, receives a device information of each of the other participant devices through the at least one wireless transceiver, measures a received signal strength indicators (RSSI) of each of the other participant devices through the at least one wireless transceiver, and obtains a distance between each of the other participant devices and the electronic device according to the device information and the RSSI of the participant device and the device information of the electronic device.

12. The electronic device according to claim 1, further comprising:
at least one wireless transceiver, wherein the electronic device is one of a plurality of participant devices, and the processor obtains distances between the participant devices through the at least one wireless transceiver, obtains a displacement of each of the participant devices through the at least one wireless transceiver and the MU, and determines a spatial location of each of the participant devices according to the distances and the displacements.

13. The electronic device according to claim 12, wherein the processor sends a device information of the electronic device to the plurality of participant devices other than the electronic device through the at least one wireless transceiver, receives a device information of each of the other participant devices through the at least one wireless transceiver, measures a received signal strength indicator (RSSI) of each of the other participant devices through the at least one wireless transceiver, obtains a distance between each of the other participant devices and the electronic device according to the device information and the RSSI of the participant device and the device information of the electronic device, sends the distance between each of the other participant devices and the electronic device to the other participant devices through the at least one wireless transceiver, and receives distances between the other participant devices through the at least one wireless transceiver.

14. The electronic device according to claim 12, wherein regarding each of the participant devices, the processor updates the spatial location of the participant device by using the displacement of the participant device to obtain a displacement positioning point, performs triangulation by using the distances between the participant device and the other participant devices to obtain a distance positioning point, and determines the spatial location of the participant device according to the displacement positioning point and the distance positioning point.

15. The electronic device according to claim 14, wherein the processor determines a combination or a plurality of combinations among the other participant devices according to a first predetermined rule, wherein each of the combinations comprises three of the other participant devices, and the processor obtains a positioning point corresponding to each of the combinations by using the distances between the three other participant devices in the combination and the participant device through triangulation and a maximum likelihood method, wherein the distance positioning point is a mean position of the positioning points of the combinations.

16. The electronic device according to claim 15, wherein the first predetermined rule is to sort the other participant devices according to the displacements of the other participant devices and then obtain all different combinations of three of the n other participant devices having the smallest displacements, wherein n is a predetermined parameter.

17. The electronic device according to claim 14, wherein the processor allocates a plurality of particles around the initial location of the participant device according to a second predetermined rule, moves the participant device to one of the displacement positioning point and the distance positioning point and moves the particles in the same direction and distance as those of the movement of the participant device, selects one of the particles as the spatial location of the participant device according to the other one of the displacement positioning point and the distance positioning point, re-allocates a plurality of particles according to a third predetermined rule, and replaces the original particles with the re-allocated particles.

18. The electronic device according to claim 17, wherein the processor calculates a displacement variance of last n displacements of the participant device and calculates a distance variance of last m average distances between the participant device and a subset of the other participant devices, wherein m and n are predetermined parameters; when the displacement variance is smaller than the distance variance, the processor moves the participant device to the displacement positioning point and moves the particles in the same direction and distance as those of the movement of the participant device; when the distance variance is smaller than the displacement variance, the processor moves the participant device to the distance positioning point and moves the particles in the same direction and distance as those of the movement of the participant device.

19. The electronic device according to claim 17, wherein the processor moves the participant device to one of the displacement positioning point and the distance positioning point and moves the particles in the same direction and distance as those of the movement of the participant device, then the processor determines a weight of each of the particles, wherein the weight of each of the particles is in inverse proportion to a distance between the particle and the other one of the displacement positioning point and the distance positioning point, and the processor selects the particle having the greatest weight as the spatial location of the participant device.

20. The electronic device according to claim 17, wherein the third predetermined rule is to input the weight of each of the original particles into a predetermined increasing function to determine a number of particles re-allocated around the original particle and then move each of the re-allocated particles according to a fourth predetermined rule, wherein an initial location of each of the re-allocated particles is the same as a location of the corresponding original particle.

21. The electronic device according to claim 14, wherein the spatial location of the participant device determined by the processor is a weighted average of the displacement positioning point and the distance positioning point, and the spatial location determined by the processor is located between the displacement positioning point and the distance positioning point.

22. The electronic device according to claim 21, wherein the processor calculates a displacement variance of last n displacements of the participant device and calculates a distance variance of last m average distances between the participant device and a subset of the other participant devices, wherein m and n are predetermined parameters, and the processor calculates the weighted average according to the displacement variance and the distance variance.

23. The electronic device according to claim 21, wherein regarding each of the other participant devices, the processor calculates a difference between the distance between the other participant device and the participant device obtained through the at least one wireless transceiver and a distance between the other participant device and the distance positioning point, calculates an error parameter according to the differences of the other participant devices, and calculates a continuous moving time of the participant device since last time the processor determines the spatial location of the participant device according to the displacement positioning point and the distance positioning point; in the calculation of the weighted average, a weight of the distance positioning point is in inverse proportion to the error parameter, and a weight of the displacement positioning point is in inverse proportion to the continuous moving time.

24. The electronic device according to claim 12, further comprising:
a display, displaying the spatial location of each of the participant devices; and
an input interface, wherein the processor receives an operation command corresponding to one of the participant devices through the input interface and transmits an electronic file to the participant device corresponding to the operation command.

25. A positioning method, executed by an electronic device, wherein the electronic device comprises at least one measurement unit (MU), the positioning method comprising:
determining an initial location of the electronic device;
obtaining a displacement of the electronic device through the MU; and
determining a spatial location of the electronic device according to the initial location and the displacement.

26. The positioning method according to claim 25, wherein the electronic device further comprises at least one wireless transceiver, the electronic device is one of a plurality of participant devices, and the positioning method further comprises:
obtaining distances between the participant devices through the at least one wireless transceiver; and
determining an initial location of each of the participant devices according to the distances through a distance-based decentralized network positioning algorithm.

27. The positioning method according to claim 26, wherein the distance-based decentralized network positioning algorithm is a Vivaldi algorithm or a rigidity theory algorithm.

28. The positioning method according to claim 27, further comprising:
obtaining a displacement of each of the participant devices through the at least one wireless transceiver and the MU; and
determining the initial location of each of the participant devices according to the distances, the displacements, and the Vivaldi algorithm.

29. The positioning method according to claim 25, wherein the electronic device further comprises at least one wireless transceiver, the electronic device is one of a plurality of participant devices, and the step of determining the initial location of the electronic device comprises:
identifying a plurality of subjects in an image of a surrounding environment;
determining an azimuth angle of each of the subjects relative to the electronic device according to a position of the subject in the image;
determining the initial location of the electronic device according to spatial locations and the azimuth angles of the subjects; and
sending the initial location to the other participant devices through the at least one wireless transceiver, wherein appearance characteristics and the spatial locations of the subjects are stored in a database in advance.

30. The positioning method according to claim 25, wherein the electronic device further comprises at least one wireless transceiver, the electronic device is one of a plurality of participant devices, and the positioning method further comprises:
calculating the displacement of the electronic device according to an output of the MU;
adding the displacement of the electronic device to the initial location or the spatial location of the electronic device to update the spatial location of the electronic device;
sending the spatial location of the electronic device to the other participant devices through the at least one wireless transceiver; and
receiving spatial locations of the other participant devices through the at least one wireless transceiver.

31. The positioning method according to claim 25, wherein the electronic device further comprises at least one wireless transceiver, the electronic device is one of a plurality of participant devices, and the positioning method further comprises:
calculating the displacement of the electronic device according to an output of the MU;
sending the displacement of the electronic device to the other participant devices through the at least one wireless transceiver;
receiving displacements of the other participant devices through the at least one wireless transceiver; and
adding the displacement of each of the plurality of participant devices to an initial location or a spatial location of the participant device to update the spatial location of the participant device.

32. The positioning method according to claim 31, wherein the MU comprises a first MU and a second MU, and the step of calculating the displacement of the electronic device according to the output of the MU comprises:
converting an output of the second MU from a device coordinate system of the electronic device to a spatial coordinate system of the plurality of participant devices according to an output of the first MU; and
integrating the output of the second MU to obtain the displacement of the electronic device.

33. The positioning method according to claim 25, wherein the electronic device further comprises at least one wireless transceiver, the electronic device is one of a plurality of participant devices, and the positioning method further comprises:
obtaining distances between the electronic device and the other participant devices through the at least one wireless transceiver;
determining the spatial location of the electronic device according to the distances and the displacement;
sending the spatial location of the electronic device to the other participant devices through the at least one wireless transceiver; and
receiving spatial locations of the other participant devices through the at least one wireless transceiver.

34. The positioning method according to claim 25, wherein the electronic device further comprises at least one wireless transceiver, the electronic device is one of a plurality of participant devices, and the positioning method further comprises:
obtaining distances between the participant devices through the at least one wireless transceiver;
obtaining a displacement of each of the participant devices through the at least one wireless transceiver and the MU; and
determining a spatial location of each of the participant devices according to the distances and the displacements.

35. The positioning method according to claim 34, wherein regarding each of the participant devices, the step of determining the spatial locations of the participant devices according to the distances and the displacements comprises:
updating the spatial location of the participant device by using the displacement of the participant device to obtain a displacement positioning point;
performing triangulation by using the distances between the participant device and the other participant devices to obtain a distance positioning point; and
determining the spatial location of the participant device according to the displacement positioning point and the distance positioning point.

36. The positioning method according to claim 35, wherein the step of performing triangulation by using the distances between the participant device and the other participant devices to obtain the distance positioning point comprises:
determining a combination or a plurality of combinations among the other participant devices according to a first predetermined rule, wherein each of the combinations comprises three of the other participant devices; and
obtaining a positioning point corresponding to each of the combinations by using the distances between the three other participant devices in the combination and the participant device through triangulation and a maximum likelihood method, wherein the distance positioning point is a mean position of the positioning points of the combinations.

37. The positioning method according to claim 35, wherein the step of determining the spatial location of the participant device according to the displacement positioning point and the distance positioning point comprises:
allocating a plurality of particles around the initial location of the participant device according to a second predetermined rule;
moving the participant device to one of the displacement positioning point and the distance positioning point and moving the particles in the same direction and distance as those of the movement of the participant device;
selecting one of the particles as the spatial location of the participant device according to the other one of the displacement positioning point and the distance positioning point; and
re-allocating a plurality of particles according to a third predetermined rule, and replacing the original particles with the re-allocated particles.

38. The positioning method according to claim 37, wherein the step of moving the participant device to one of the displacement positioning point and the distance positioning point and moving the particles in the same direction and distance as those of the movement of the participant device comprises:
calculating a displacement variance of last n displacements of the participant device, and calculating a distance variance of last m average distances between the participant device and a subset of the other participant devices, wherein m and n are predetermined parameters;
when the displacement variance is smaller than the distance variance, moving the participant device to the displacement positioning point and moving the particles in the same direction and distance as those of the movement of the participant device; and
when the distance variance is smaller than the displacement variance, moving the participant device to the distance positioning point and moving the particles in the same direction and distance as those of the movement of the participant device.

39. The positioning method according to claim 37 further comprising:
moving the participant device to one of the displacement positioning point and the distance positioning point and moving the particles in the same direction and distance as those of the movement of the participant device, then determining a weight of each of the particles, wherein the weight of each of the particles is in inverse proportion to a distance between the particle and the other one of the displacement positioning point and the distance positioning point; and
selecting the particle having the greatest weight as the spatial location of the participant device.

40. The positioning method according to claim 35, wherein the spatial location of the participant device determined according to the displacement positioning point and the distance positioning point is a weighted average of the displacement positioning point and the distance positioning point, and the spatial location is located between the displacement positioning point and the distance positioning point.

41. The positioning method according to claim 34, further comprising:
displaying the spatial location of each of the participant devices;
receiving an operation command corresponding to one of the participant devices; and
transmitting an electronic file to the participant device corresponding to the operation command.

42. A computer program product, comprising a positioning program, wherein the positioning method in claim 25 is accomplished when an electronic device loads and executes the positioning program.

43. A computer-readable recording medium, comprising a positioning program, wherein the positioning method in claim 25 is accomplished when an electronic device loads and executes the positioning program.

44. A positioning system, comprising:
a plurality of electronic devices, wherein each of the electronic devices comprises a first wireless transceiver, a second wireless transceiver, and at least one measurement unit (MU); each of the electronic devices obtains distances between the electronic device and the other electronic devices through the first wireless transceiver and obtains a displacement of the electronic device through the MU; and
a server, wherein each of the electronic devices sends the distances and the displacement to the server through the second wireless transceiver, and the server determines a spatial location of each of the electronic devices according to the distances and the displacements.

45. The positioning system according to claim 44, wherein each of the electronic devices sends a device information of the electronic device to the other electronic devices through the first wireless transceiver, receives device information of each of the other electronic devices through the first wireless transceiver, measures a received signal strength indicator (RSSI) of each of the other electronic devices through the first wireless transceiver, and obtains a distance between each of the other electronic devices and the electronic device according to the device information and the RSSI of the other electronic device and the device information of the electronic device.

46. The positioning system according to claim 44, wherein the server determines an initial location of each of the electronic devices according to the distances through a distance-based decentralized network positioning algorithm.

47. The positioning system according to claim 46, wherein the distance-based decentralized network positioning algorithm is a Vivaldi algorithm or a rigidity theory algorithm.

48. The positioning system according to claim 47, wherein the server determines the initial location of each of the electronic devices according to the distances, the displacements, and the Vivaldi algorithm.

49. The positioning system according to claim 44, wherein each of the electronic devices identifies a plurality of subjects in an image of a surrounding environment, determines an azimuth angle of each of the subjects relative to the electronic device according to a position of the subject in the image, determines the initial location of the electronic device according to spatial locations and the azimuth angles of the subjects, and sends the initial location to the server through the second wireless transceiver, wherein appearance characteristics and the spatial locations of the subjects are stored in a database in advance.

50. The positioning system according to claim 44, wherein each of the electronic devices obtains an image of a surrounding environment and sends the image to the server through the second wireless transceiver; the server identifies a plurality of subjects in the image, determines an azimuth angle of each of the subjects relative to the electronic device according to a position of the subject in the image, and determines the initial location of the electronic device according to spatial locations and the azimuth angles of the subjects, wherein appearance characteristics and the spatial locations of the subjects are stored in a database in advance.

51. The positioning system according to claim 44, wherein each of the electronic devices calculates the displacement of the electronic device according to an output of the MU.

52. The positioning system according to claim 51, wherein the MU comprises a first MU and a second MU, and the electronic device converts an output of the second MU from a device coordinate system of the electronic device to a spatial coordinate system of the electronic devices according to an output of the first MU and integrates the output of the second MU to obtain the displacement of the electronic device.

53. The positioning system according to claim 52, wherein the first MU is a gyroscope or an e-compass, and the second MU is an accelerometer.

54. The positioning system according to claim 51, wherein the server adds the displacement of each of the electronic devices to the spatial location of the electronic device to update the spatial location of the electronic device.

55. The positioning system according to claim 44, wherein regarding each of the electronic devices, the server updates the spatial location of the electronic device by using the displacement of the electronic device to obtain a displacement positioning point, performs triangulation by using the distances between the electronic device and the other electronic devices to obtain a distance positioning point, and determines the spatial location of the electronic device according to the displacement positioning point and the distance positioning point.

56. The positioning system according to claim 55, wherein the server determines a combination or a plurality of combinations among the other electronic devices according to a first predetermined rule, wherein each of the combinations comprises three of the other electronic devices; the server obtains a positioning point corresponding to each of the combinations by using the distances between the three other electronic devices in the combination and the electronic device through triangulation and a maximum likelihood method, wherein the distance positioning point is a mean position of the positioning points of the combinations.

57. The positioning system according to claim 56, wherein the first predetermined rule is to sort the other electronic devices according to the displacements of the other electronic devices and then obtain all different combinations of three of the n other electronic devices having the smallest displacements, wherein n is a predetermined parameter.

58. The positioning system according to claim 55, wherein the server allocates a plurality of particles around the initial location of the electronic device according to a second predetermined rule, moves the electronic device to one of the displacement positioning point and the distance positioning point and moves the particles in the same direction and distance as those of the movement of the electronic device, selects one of the particles as the spatial location of the electronic device according to the other one of the displacement positioning point and the distance positioning point, re-allocates a plurality of particles according to a third predetermined rule, and replaces the original particles with the re-allocated particles.

59. The positioning system according to claim 58, wherein the server calculates a displacement variance of last n displacements of the electronic device and calculates a distance variance of last m average distances between the electronic device and a subset of the other electronic devices, wherein m and n are predetermined parameters; when the displacement variance is smaller than the distance variance, the server moves the electronic device to the displacement positioning point and moves the particles in the same direction and distance as those of the movement of the electronic device; when the distance variance is smaller than the displacement variance, the server moves the electronic device to the distance positioning point and moves the particles in the same direction and distance as those of the movement of the electronic device.

60. The positioning system according to claim 58, wherein the server moves the electronic device to one of the displacement positioning point and the distance positioning point and moves the particles in the same direction and distance as those of the movement of the electronic device, then the server determines a weight of each of the particles, wherein the weight of each of the particles is in inverse proportion to a distance between the particle and the other one of the displacement positioning point and the distance positioning point, and the server selects the particle having the greatest weight as the spatial location of the electronic device.

61. The positioning system according to claim 58, wherein the third predetermined rule is to input the weight of each of the original particles into a predetermined increasing function to determine a number of particles re-allocated around the original particle and then move each of the re-allocated particles according to a fourth predetermined rule, wherein an initial location of each of the re-allocated particles is the same as a location of the corresponding original particle.

62. The positioning system according to claim 55, wherein the spatial location of the electronic device determined by the server is a weighted average of the displacement positioning point and the distance positioning point, and the spatial location determined by the server is located between the displacement positioning point and the distance positioning point.

63. The positioning system according to claim 62, wherein the server calculates a displacement variance of last n displacements of the electronic device and calculates a distance variance of last m average distances between the electronic device and a subset of the other electronic devices, wherein m and n are predetermined parameters, and the server calculates the weighted average according to the displacement variance and the distance variance.

64. The positioning system according to claim 62, wherein regarding each of the other electronic devices, the server calculates a difference between the distance between the other electronic device and the electronic device obtained through the first wireless transceiver and a distance between the other electronic device and the distance positioning point, calculates an error parameter according to the differences of the other electronic devices, and calculates a continuous moving time of the electronic device since last time the server determines the spatial location of the electronic device according to the displacement positioning point and the distance positioning point; in the calculation of the weighted average, a weight of the distance positioning point is in inverse proportion to the error parameter, and a weight of the displacement positioning point is in inverse proportion to the continuous moving time.

65. The positioning system according to claim 44, wherein each of the electronic devices receives the spatial locations of the electronic devices from the server through the second wireless transceiver.

66. The positioning system according to claim 65, wherein each of the electronic devices further comprises:
a display, displaying the spatial location of each of the electronic devices; and
an input interface, wherein one of the electronic devices receives an operation command corresponding to another one of the electronic devices through the input interface and transmits an electronic file to the electronic device corresponding to the operation command.
